(19) United States
(12) Patent Application Publication
(10) Pub. No.: US 2024/0315927 A1
(43) Pub. Date: Sep. 26, 2024

(54) SMART MULTI-MEDICATION DISPENSER SYSTEM

(71) Applicant: RxCap, Inc., Lynnfield, MA (US)

(72) Inventors: Ram Subramanian, Fremont, CA (US); Sreeram Ramakrishnan, Lynnfield, MA (US); Michael Furlotti, Ross, CA (US); Mahesh Mistry, Simi Valley, CA (US)

(21) Appl. No.: 18/614,184

(22) Filed: Mar. 22, 2024

Related U.S. Application Data
(60) Provisional application No. 63/454,026, filed on Mar. 22, 2023.

(51) Int. Cl. A61J 7/00; A61J 1/03; A61J 7/02; B65D 83/04

(52) U.S. Cl. CPC A61J 7/0084; A61J 1/035; A61J 7/02; B65D 83/0472

(57) ABSTRACT

A smart container for holding a pre-prepared strip of serially connected pill packets, such as a strip stored in a box with each packet containing at least one medication, includes a housing having plural walls defining a space to receive the strip of pill packets; a lid secured to the housing, the lid being movable between open and closed positions, the space being accessible when the lid is in the open position; a dispensing portal disposed at a predetermined position of the housing, the strip of pill packets being dispensable through the dispensing portal; and a guiding mechanism interconnected with the lid. The guiding mechanism engages the strip of pill packets when the strip of pill packets is disposed in the space and aligned in the dispensing portal and the lid is moved to the closed position.

### CROSS-REFERENCE TO RELATED APPLICATIONS

This application claims the benefit under 35 U.S.C. § 119(e) of U.S. Provisional Patent Application No. 63/454,026, filed Mar. 22, 2023, and titled “SMART MULTI-MEDICATION DISPENSER SYSTEM,” the entirety of which is incorporated herein by reference.

### FIELD OF THE INVENTION

The invention relates to dispensing of multi-medication regimens in locations such as, but not limited to, patients' homes and non-hospital facilities like nursing homes. The invention enables proper dosing and increased medication adherence outside of hospital and other medically-supervised settings like doctors' offices, particularly for patients undergoing multi-medication regimens. In particular, the present invention provides a solution for reliable and monitored medication dispensing.

Medication non-compliance is a major concern in health care. Medications in the form of pills, capsules, gel-caps, pellets, tablets, etc., are typically provided to a user in a disposable plastic container with a cap, such as a childproof cap. When physicians prescribe medications, they typically advise the patients of a proper medication administration, such as to take the medication at appropriate times in appropriate quantities, to continue taking the medication for the full prescribed regimen, even if the patient feels better, etc. Unfortunately, many patients exhibit poor compliance in properly following the regimens set out by their physicians.

A variety of products and techniques for reminding patients to take their medications, as prescribed, are known. Some compliance intervention systems offered by health care providers are designed to remind the patient to take the medication and alert a remote caregiver if the patient does not comply with taking the medication as prescribed. Some of these compliance intervention systems include sensors/reminders in the home, a network connection, and outbound messaging to a caregiver or even back to the patient.

The problem of medication non-compliance is particularly pronounced when a patient is prescribed a multi-medication regimen. As discussed below, multi-medication pill pack dispensers are available, but what is needed is a system of monitoring and dispensing of such multi-medications in a reliable, inexpensive, and secure manner.

### BACKGROUND OF THE INVENTION

Multi-medication pill pack dispensers are known. Note, for example, ExactPack™ from Exact Care Pharmacy, PillPack™ by Amazon, and SimpleDose™ by CVS. In a typical system, for example, a patient can receive a prescription and then order a box of multi-medication packets or pouches (MDPs) for a month supply, for example. See example MDP boxes 10 shown in FIG. 10. The provider, such as a pharmacy, will fill the prescriptions for the various medications or supplements (like vitamins) P and provide a roll (as shown in phantom in FIG. 10) of pre-filled packets 12 (see FIG. 11, for example) in the box 10 for each dosing time. The medications are sorted by the day and time the patient should take them. The packets are typically stored in MDP box 10 and the end of the roll can be pulled out of the box at dispensing opening 10a and torn off at a perforation between packets 12. The separated packet 12 is then torn open, and the medications taken by the patient. Each packet 12 will list information 14 including, for example, the name, strength, and dosage of the medications contained therein. In addition, each box 10 can include a label 10b with the contents of the various packets 12 stored therein. Each box 10 can contain packets 12 with differing contents, such as if the number/kinds of medications differ from day to day, or even in the same day.

### SUMMARY OF THE INVENTION

The smart multi-medication dispenser system of the present invention can allow care management by tracking medication compliance for complex disease management, particularly when using multi-medication pill packs. The system is usable with a smart multi-medication dispenser device that can be easy-to-use for the patient, with a minimal learning curve. The system can support most, if not all, existing multi-medication pill packaging, and also can be used in conjunction with unit-of-use medications. The system can be used in conjunction with an adherence monitoring portal, use LTE cellular data transmission (such as 5G cellular capability), be easy to integrate adherence data into pharmacy and electronic health record (EHR) systems, and be simple to incorporate into existing enterprise script production workflows.

In one aspect, the invention relates to a container for holding a pre-prepared strip of serially connected pill packets, each packet containing at least one medication, the container comprising a housing having plural walls defining a space to receive the strip of pill packets; a lid secured to the housing, the lid being movable between open and closed positions, the space being accessible when the lid is in the open position; a dispensing portal disposed at a predetermined position of the housing, the strip of pill packets being dispensable through the dispensing portal; and a guiding mechanism interconnected with the lid, the guiding mechanism engaging the strip of pill packets when the strip of pill packets is disposed in the space and aligned in the dispensing portal and the lid is moved to the closed position.

In another aspect, the invention relates to a method of using a container for holding a pre-prepared strip of serially connected pill packets, each containing at least one medication, the container comprising a housing having plural walls defining a space to receive the strip of pill packets, a dispensing portal disposed at a predetermined position of the housing, the strip of pill packets being dispensable through the dispensing portal, and at least one sensor, the method comprising sensing whether a length of the strip of pill packets has been drawn through the dispensing portal, and storing or transmitting information regarding the length of the strip of pill packets having been drawn through the dispensing portal.

In a further aspect, the invention relates to a system for dispensing a pre-prepared strip of serially connected pill packets, each packet containing at least one medication, the system comprising a container for holding the pre-prepared strip of serially connected pill packets, the container including a housing defining a space to receive the strip of pill packets, a dispensing portal disposed in the housing, the strip of pill packets being dispensable through the dispensing portal, a guiding mechanism engaging the strip of pill packets when the strip of pill packets is disposed in the space with a leading end of the strip aligned in the dispensing portal, a flap selectively covering the dispensing portal, at least one sensor for sensing a component of the container, a controller in communication with the at least one sensor, and a communication module connected to the controller; and a control portal in communication with the controller, wherein the controller and control portal control at least one of determining when a packet is to be dispensed from the container, monitoring whether the strip of pill packets has moved through the dispensing portal, determining the distance the strip of pill packets has moved through the dispensing portal, monitoring whether the flap has been moved, or transmitting to the control portal information regarding the container or any components of the container.

These and other aspects of the invention will become apparent from the following disclosure.

### BRIEF DESCRIPTION OF THE DRAWINGS

FIG. 1 is a perspective view of a smart container according to an embodiment of the present invention.

FIG. 2 is a perspective view of the smart container shown in FIG. 1 with its dispensing flap opened.

FIG. 3 is a perspective view of the smart container shown in FIG. 1 with its lid opened.

FIG. 4 is a perspective view including a modification of the smart container shown in FIG. 1 with its lid opened and a multi-medication box being inserted.

FIG. 5 is a perspective view of a smart container according to the modified embodiment of the present invention.

FIG. 6 is a perspective view of a smart container according to another embodiment of the present invention.

FIG. 7 is a block diagram showing electrical components of a smart container according to an embodiment of the present invention.

FIG. 8 is a flow chart of a method of usage and communication control in the smart dispenser system of the present invention.

FIG. 9 is a flow chart of a method of filling the smart container of the present invention.

FIG. 10 is a perspective view of known multi-medication boxes usable with the smart container according to the present invention.

FIG. 11 are views of known multi-medication packets usable with the smart container according to the present invention

### DETAILED DESCRIPTION OF THE PREFERRED EMBODIMENTS

The present invention relates to an apparatus, method, and system for using an intelligent dispensing container used to dispense articles, particularly medicine for a patient as stored in packets holding multiple medications, and for monitoring its usage. In a preferred embodiment, the dispensed medicine is in the form of pills. The term “pills,” as used herein, refers to any of capsules, gel-caps, pellets, tablets, or the like, in any particular shape or size. However, as would be understood by one of ordinary skill in the art, the present invention is not limited to only dispensing medicine, but may be used to dispense any suitable items, especially those in which compliance is monitored and those provided in plural in a strip of prefilled, serially-connected packets, also known as multi-dose packaging (MPD).

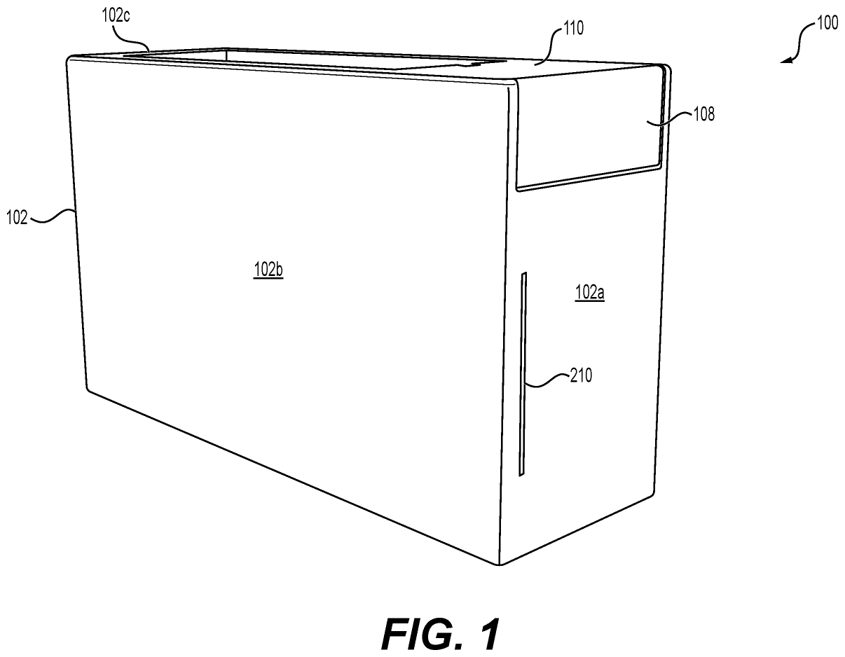

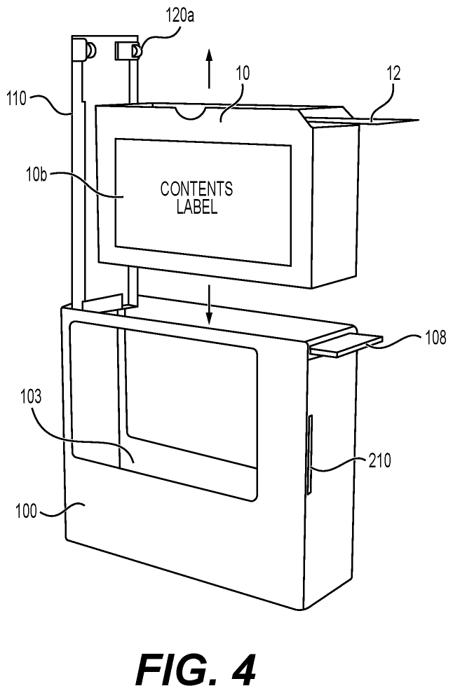

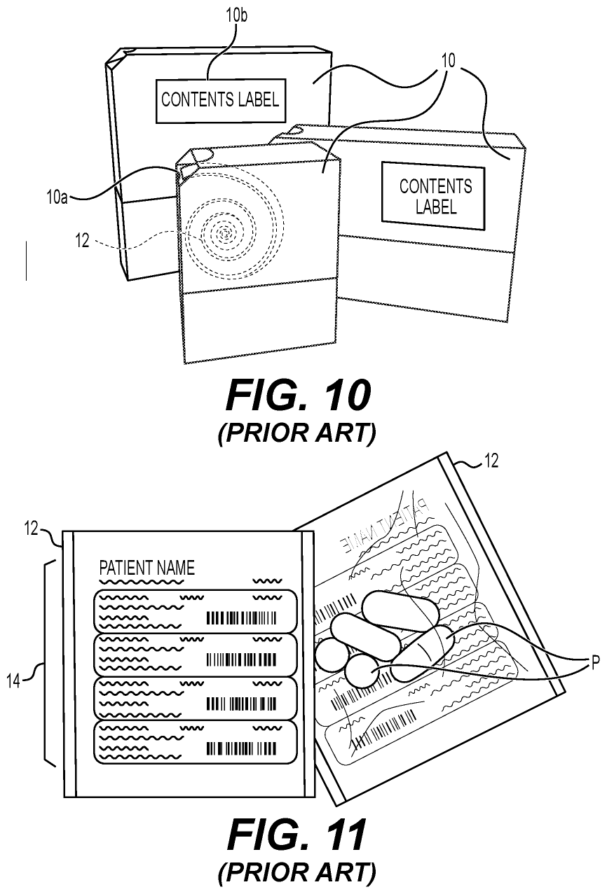

FIGS. 1-4 are perspective views of a smart multi-medication dispenser, also identified as a smart container 100, according to an embodiment of the present invention, although FIG. 4 shows a version of the container modified from that of FIGS. 1-3. The smart multi-medication dispenser device or smart container 100 includes a main housing 102 with a hollow interior defining a receiving space 104 for receiving pill pack medication boxes, or multi-medication boxes 10, such as those shown in FIG. 10. As available multi-medication boxes 10 are typically of a rectangular cuboid shape, the walls of housing 102 are also of a rectangular cuboid shape slightly larger than the box 10 intended to be received. Thus, the receiving space 104 has a rectangular cuboid shape of dimensions complementary to the dimensions of the box 10. In the shown embodiment, main housing 102 includes six orthogonally-connected walls 102a-102f, only some of which are shown in the drawings.

The shown walls 102 include front wall 102a, obverse side wall 102b, and top wall 102c. Rear, reverse side, and bottom walls are not shown in the figures. Top wall 102c does not fully cover the top side of housing 102, but rather defines an opening 103 to allow insertion and removal of box 10. Opening 103 should have peripheral dimensions of sufficient size to allow insertion and removal of box 10 without interference. Main housing 102, as well as other components of the container, can be made of any suitable materials manufactured in any known manner. For example, the housing can be made of injection molded plastics, but such is not to be limiting. Preferably, the material is opaque or of such characteristics that will protect box 10 and its contents from environmental conditions, such as from UV light exposure.

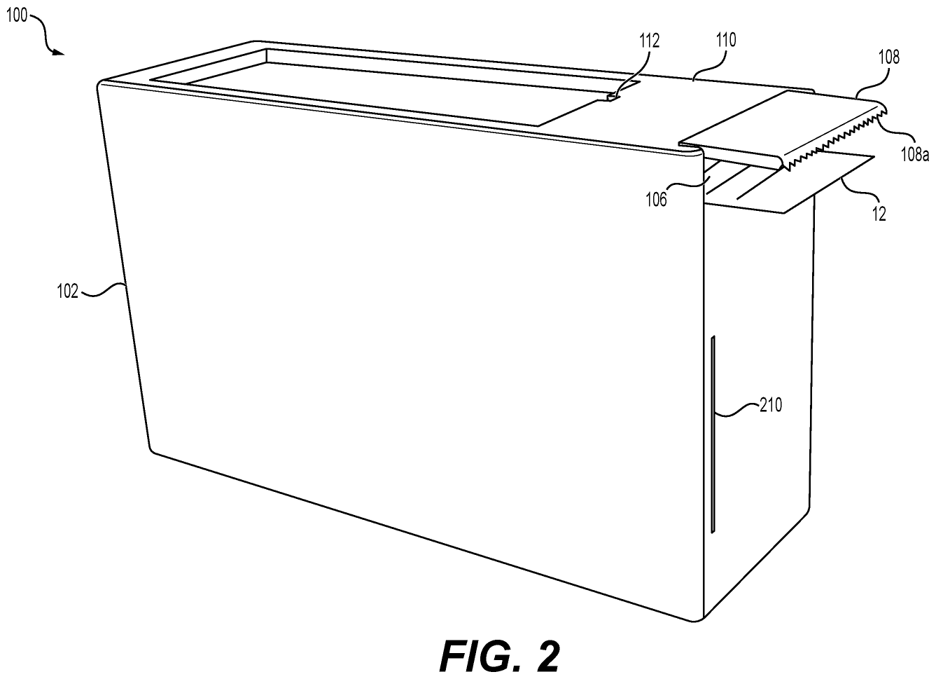

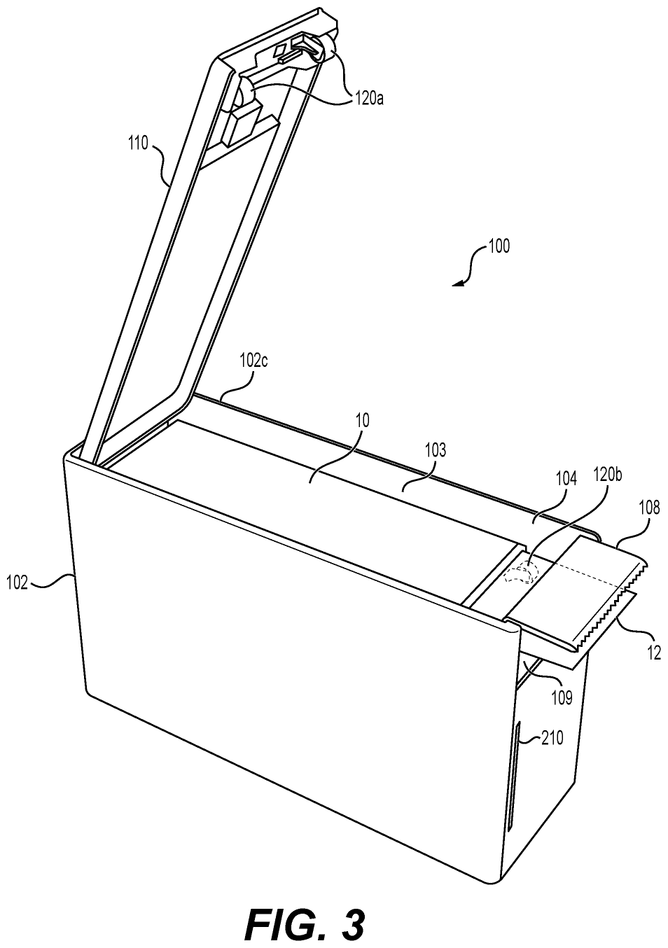

A lid mechanism 110 is hinged or otherwise connected to main housing 102 and is movable between an open position as shown in FIG. 3 and a closed position as shown in FIGS. 1 and 2. When in the open position, lid mechanism 110 allows access to the space 104 within in the main housing 102 for inserting new or removing used pill pack medication boxes 10. The lid mechanism 110 includes a locking/release mechanism 112 to lock the lid mechanism in the closed position or release the lid mechanism to allow it to be opened. Locking/release mechanism 112 can be of any known construction, such as a spring-biased latching mechanism. In the shown embodiment, the locking/release mechanism 112 includes a spring (not shown) slide member provided on the lid mechanism 110 that engages with an unshown catch in housing 102 near the front edge of opening 103.

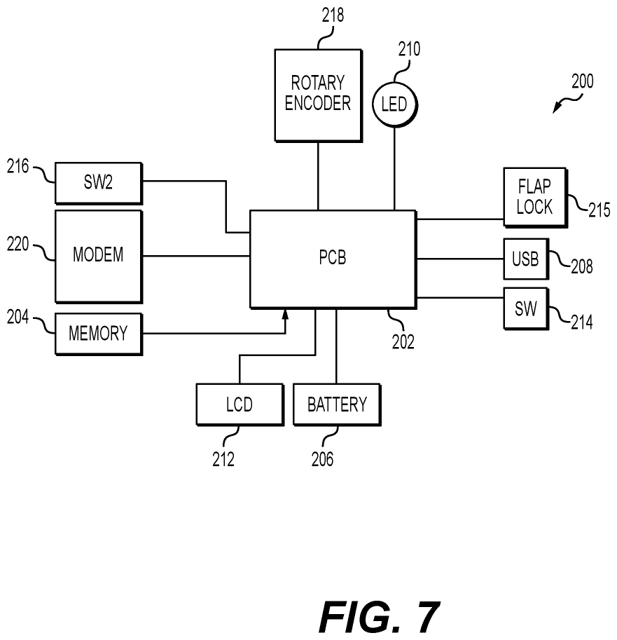

A dispensing portal 106 is provided on front wall 102a of housing 102. When a multi-medication box 10 is inserted in housing 102, the strip of medicine packets 12 can be dispensed through portal 106. In the shown embodiment, the dispensing portal 106 is disposed at the upper side of front wall 102a so that the strip of packets 12 can be dispensed at the upper, front region of the container 100. The housing is further provided with a flap mechanism 108 that can include an integrated cutter 108a. Flap mechanism 108 is hinged or otherwise connected to front wall 102a of housing 102, and is movable between a dispensing position as shown in FIG. 2, or a closed position as shown in FIGS. 1 and 3. Preferably, front wall 102a includes a recess 109 so that when in the closed position, flap mechanism 108 can be flush with the exterior surface of front wall 102a. Recess 109 preferably is of sufficient depth to accommodate both the flap mechanism 108 and the lead end of the strip of packets 12. When in the open position, flap mechanism 108 exposes dispensing portal 106 so that the strip of medicine packets can be pulled through the portal. After a single packet is pulled through the portal and is disposed outside of the container 100, it can be cut off and separated from the other packets in the strip roll by using cutter 108a. When in the closed position, flap mechanism 108 closes portal 106 and prevents any medicine packets from being withdrawn from the container. Flap mechanism 108 can be locked electronically (locking device 215 schematically shown in FIG. 7) as a child-proof measure and/or to control the available dispensing times. The flap locking device 215 can be any known locking mechanism, such as a solenoid-operated or magnetically-controlled latch. As discussed below, a sensor device is interconnected with flap mechanism 108 so that the container can determine whenever the flap mechanism is opened and closed. As an option, an optical reader can be provided, such as on flap mechanism 108, so as to detect movement of packets 12 and/or enable reading of information printed on the packets.

Container 100 is further provided with a guiding mechanism 120 to secure and guide the strip of medicine packets 12 through the dispensing portal 106. In a preferred embodiment, guiding mechanism 120 includes one or more first rollers 120a connected to lid mechanism 110 and one or more complementary second rollers 120b connected to main housing 102. Preferably, first rollers 120a are disposed at a distal edge of lid mechanism 110, which will be close to front wall 102a when lid mechanism 110 is in the closed position. Second rollers 120b are disposed near the front side 102a of container 100 such that first rollers 120a will contact second rollers 120b when the lid mechanism 110 is closed and a medicine packet 12 has not been fed through the dispensing portal 106. If a medicine packet from the multi-medicine box 110 has been fed through the dispensing portal, then first and second rollers 120a, 120b pinch the lead medicine packet 12 therebetween. Rollers 120a, 120b can have grooved edges to securely engage the packets therebetween. Further, the rollers can be designed to have some resistance to require a sufficient force to pull the strip of medicine packets therethrough. At least one set of the rollers 120a, 120b can be spring-loaded so that the rollers can provide a consistent pinching force.

FIG. 7 is a block diagram showing electronic system 200 of the smart container 100 according to an embodiment of the present invention. The system includes a controller 202 in the form of, for example, a printed circuit board (PCB), which receives and transmits signals from and to the several electrical/electronic components of the smart container 100. Controller 202 is provided with any suitable memory 204 that it can use as a workspace and to store and retrieve data and programs. Although the physical location of the PCB 202 is not critical, it can be positioned in or on the lid mechanism 110 as shown in FIG. 3. The controller 202 and other components can be powered by means of a battery 206 that can be replaceable or charged by a power supply, in one example, by USB-C cable and power supply 208. In another example, a wireless charging system may be used (e.g., similar to an inductive charger used by mobile devices). The system further includes sensors or encoders to monitor the various components, as will be described below.

In a preferred environment, the system 200 includes a first switch (SW1) 214 that indicates whether flap mechanism 108 is in its open or closed position. Switch 214 can provide the status of the flap mechanism 108 to controller 202. Sensor 214 can be of any known type, such as contact sensor or light emitting and receiving sensors. As noted above, guide mechanism 120 can monitor the length of the strip of medicine packets 12 that has been pulled through the dispensing portal 106. This can be effected by providing one of first rollers 102a or second rollers 102b with a rotary encoder 218. Rotary encoder 218 provides signals to controller 202 in proportion to the number of rotations of its associated roller, which can be interpolated into the dispensed length of the medicine roll. By monitoring the dispensed length of the medicine roll, the number of packets that have been dispensed can be determined and stored. Other switches may be used, such as a second switch (SW2) 216 that can determine whether lid mechanism 104 is opened or closed.

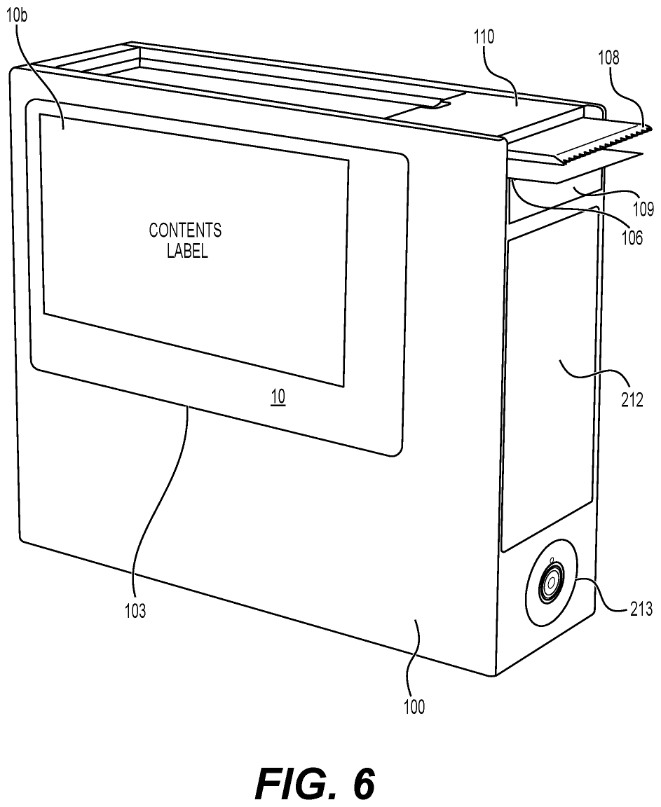

Electronic system 200 is further provided with one or more indicators disposed on the exterior of container 100. In a preferred embodiment, a light emitting diode (LED) panel or strip 210 is provided on one side of the container, such as front side 102a, as is shown in the figures. Controller 202 can control LED panel 210 in any preferred manner. For example, the LED can be switched among various colors to provide various status indications, as will be discussed in more detail below. In addition to or alternatively to LED strip 210, container 100 can be provided with an LCD display 212 as shown in FIG. 6. LED strip 210 and/or LCD panel 216 can be used to alert and otherwise communicate information to the user. Electronic system 200 can further include any known type of ON/OFF switch 213.

As non-limiting examples, controller 202 can control LED panel 210 to flash green when the patient or caregiver opens the flap 108 and tears off an MDP packet, flash blue if a second medication packet is removed within a period, for example, two hours, of the previous dispensing, thus indicating potential medication errors, or flash orange to indicate low battery levels. Of course, the application is not to be limited to these specific color/status combinations. Additional colors and statuses can be implemented, and the device is not to be limited to the use of LED lighting as the indicators. Any other visual, audible, or tactile indicator known to those of ordinary skill in the art can be used in place of or in combination with LED lighting.

If the LED screen 212 shown in FIG. 6 is used in conjunction with, or in place of the LED panel, the screen can indicate the time for the next medication with color-coding. For example, the screen 212 will light as solid purple for a time period until 20 minutes before the next medication is scheduled, solid green between 20 and 5 minutes, blinking green when the dosage is due in 5 minutes, and blinking red when late, but still permissible to take. LED screen 212 can also display an adherence score that is color-coded by value, a date for refill or use counter, color-coded to show proximity to refill or empty status, and a battery indicator for an offline mode.

The smart container 100 is also provided with a transceiver 220 in addition to or in place of USB port 208 connected to controller 202. This allows communication with the smart container 100 remotely or directly. In this manner, any information stored in memory 204 can be downloaded so as to track dispensing times and compliance. These connections can also be used to program the controller 202 when needed, such as when upgrading its software.

Smart container 100 is most effectively used in a system in conjunction with a web-based control portal, such as an adherence monitoring portal, which can be a white-labeled remote care portal for a patient care team and includes analytics, insights, and engagement with patients to better manage their care. The portal will include patient workflow for use of the smart container 100 and replacement of medication packet boxes, as follows. Controller 202 of container 100 can communicate with the portal, which can be cloud-based, using transceiver 220. Communications between the user (patient) or his or her care team can be effected either with the LCD panel 212 of the smart container 100 or with another device, such as the user's smart phone. With the smart container 100 communicating with the adherence monitoring portal, the system can, upon initial start-up, issue a welcome message for patient onboarding via SMS, so as to reduce caregiver time. The system can further provide medication reminders via SMS whereby the patient (and/or caregiver) will receive an SMS medication reminder. Automatic data transfer can occur whereby data is automatically transferred from the smart dispensing device to the portal for review by a care team member. When the prescription needs to be refilled if the medication box 10 is running low, the patient or caregiver will be alerted with a refill reminder. Then, if the prescription is refilled, the caregiver or patient is issued a medication box refill and the caregiver or patient loads the newly-refilled medication box 10 into the smart container 100 and usage and monitoring continue as before. Any further correspondence, support, and help can be handled via SMS.

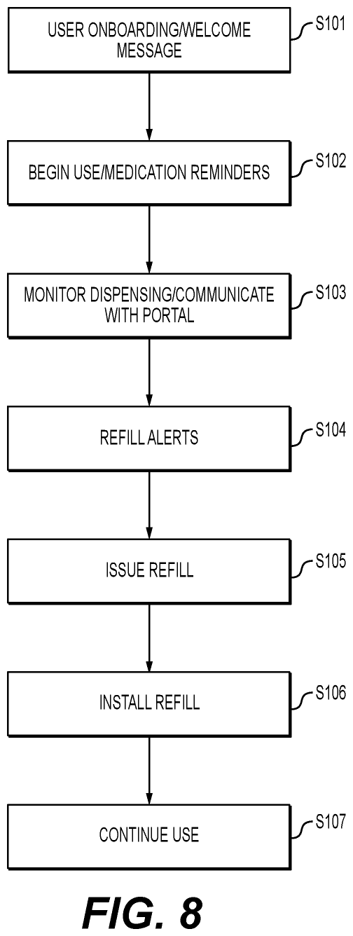

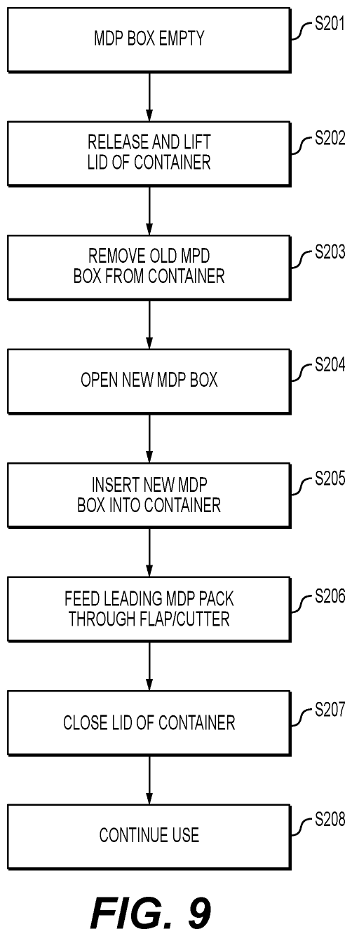

A more detailed operation of the smart container within the system will be provided with reference to the flowchart of FIG. 8. When the user, such as the patient or the patient's caregiver, acquires a new smart container 100, the system will begin onboarding at step S101 and can issue a welcome message via SMS, which can include a video or other media describing how to use the device so as to reduce caregiver time. Loading an initial MDP box 10 or replacing an empty MDP box will be described later with reference to FIG. 9. In step S102, usage begins and reminders will be issued via SMS regarding when to take the next doses of medication. Controller 202 of smart container 100 communicates with the adherence portal in step S103 regarding information sensed or recorded by the container, such as whether the flap 108 has been opened, whether the strip of packets 12 has been withdrawn or reinserted and by what distance, etc. Such communication can be continuous or periodic. Based on information processed by controller 202 or the adherence portal, the system can determine how many medication packets remain in the container 100. When the medication is running low, the patient or caregiver can be issued a message or alert via SMS for refill management in step S104, and after the prescription is refilled and a new MDP box is received in step S105, the new box is loaded in step S106 in the same manner as the original MDP box 10. Usage and monitoring then continues in step S107 as was done previously.

Loading the initial MDP box 10 or replacing an empty MDP box will now be described with reference to FIG. 9. When an initial MDP box 10 is to be loaded or when no packets from a previously-loaded MDP box 10 are visible, that is when there are no more packets to tear off, the process of loading a full MDP box begins at step S201. Initially, lid mechanism 110 is released and lifted in step S202 by pushing the slide of locking/release mechanism 112 and then raising the hinged lid mechanism to open the space 104 of housing 102. In step S203, if replacement is to be performed, the depleted MDP box is removed by grasping the empty box and removing it from the smart container through opening 103. In step S204, a new MDP box 10 is opened, while slightly pulling the lead medication packet 12 outwardly. The newly opened MDP box 10 is inserted into the space 104 of smart container 100 through opening 103 in step S206, while feeding the leading MDP packet through the dispensing portal 106 with the flap 108 in the opened position in step S206. In step S207, lid mechanism 110 is firmly closed so that locking/release mechanism 112 clicks into place. Normal usage of the smart container 100 and monitoring can now continue in step S208.

As noted above, an alert device can be provided in the smart container 100 in order to alert a user of the time to take the medication (for example, the reminders discussed above) or of errors in the system. For example, if at any stage in dispensing the smart container 100 determines there is an error, either due to the medication dosing or the system, an alert can be activated to notify the user or caregiver. The alert device may be an audio alarm, a visual alarm, or a combination thereof. The visual alarm may be issued via the LED panel 204 shown in FIG. 1 or the LCD display 212 shown in FIG. 6. The audio alarm will emit an audible signal through an unshown and optional speaker when it is time for a user to take the medication.

Rolls of packets 12 can be pre-filled, for example, at a pharmacy by a pharmacist or other authorized personnel or at another facility in any known manner, and then the rolls are inserted in an appropriately sized box 10. Smart containers 100 can be designed in several sizes to accommodate different sizes of boxes 10. Alternatively, smart containers 100 can be made in a standard size and custom sized inserts provided to shrink the space 104 to accommodate the size of the box 10 to be inserted.

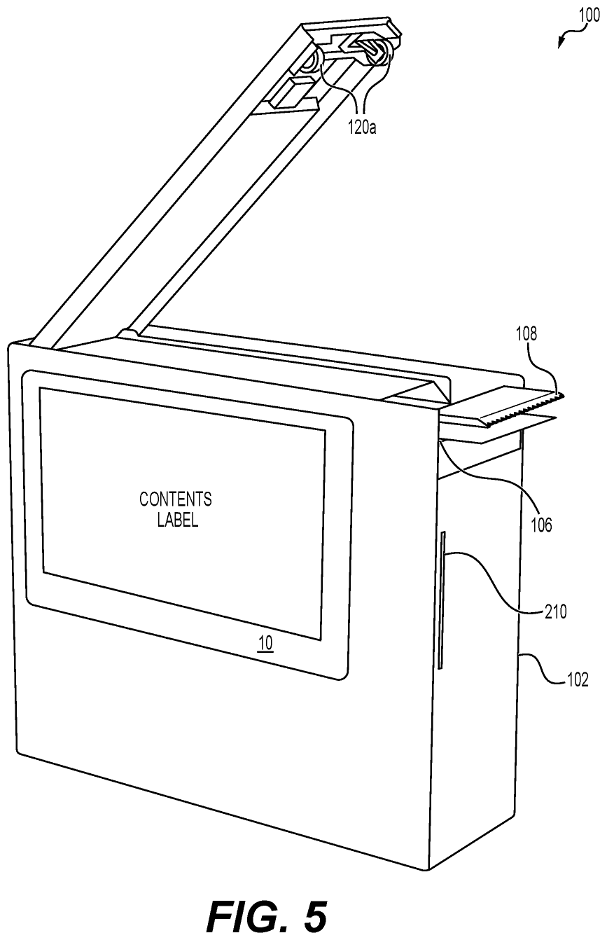

In a modification of the smart container 100, as shown in FIGS. 4-6, the smart container 100 can include a transparent display window 103 on at least one side of the housing 102, providing a clear view of the installed medication pack box 10. This allows the patient to read and identify the brand and medication information directly from the packaging. In the shown embodiment, the window 103 is provided on side 102b of housing 102 so as to align with the label 10b on the box 10.

The pill smart container 100 can keep a timestamp of every type of event in memory 204 of the controller 202. Events can include, for example, a successful dispensing of a packet 12 at the correct time, reinsertion of a packet 12, successful dispensing at an incorrect time, and unsuccessful dispensing.

The smart container 100 can utilize transceiver 220 to send and receive communications regarding user, prescription, and compliance information. The transceiver may be Zigbee and/or Bluetooth technology, a cell modem, an RFID transmitter, or any other known device for sending and receiving information. The smart container 100 may utilize more than one transceiver 220 for redundancy. For example, the smart container 100 can contain a cell modem and Bluetooth and/or Zigbee technology.

The cell modem will allow the controller 202 to send messages, via SMS text or any other suitable protocol such as TCP/IP, to a central server so as to report compliance data of a user, any malfunctions, or any misuse of the medication that is sensed by the smart container 100. The Bluetooth or Zigbee technology allows for the device to be able to quickly interact with the pharmacy computing system. The pharmacy computer will detect the smart container 100 and its unique ID and will download any necessary data to the smart container 100.

Information from the cell modem may also be used by an external server to send messages to any outside source, for example, a user's family or friends, a caretaker, doctor, other healthcare provider, a researcher, pharmaceutical company, a pharmacy for refills, etc., as needed or desired.

While the smart container 100 has been described as having a battery as power source 206, the smart container 100 is not limited to a battery for power supply, but rather any power source may be used to power the smart container 100.

The system, using controller 202 and/or the adherence portal, can determine when to indicate to a user it is time to take the medication from an MDP packet. The system determines if time has elapsed for the next dose of the medication as prescribed by the information stored in the memory 204 and/or information from a remote server of the adherence portal. More specifically, the system determines if the elapsed time is greater than a prescribed time interval. If yes, the system activates an alert indicating to the user that it is time to take the medication. For ease of example, only a visual alert, such as via LED strip 210 or LCD panel 212 will be described. If the prescribed time has elapsed, the alert will flash an appropriate color light indicating to the user it is time to dispense and take the medication. If the prescribed time has not yet elapsed, the alarm will not flash. The system monitors whether an MDP packet 12 has been removed from container 100, and if so, the alert will be deactivated and the system will again begin monitoring the elapsed time to determine when next to alert the user to dispense the next MDP packet 12 based on stored specifications.

The smart medication dispensing system of the present invention includes many features that are advantageous to improving medication compliance. The system can track the flap opening and closing to register dispensing as well as track MDP box replacement. It can allow for locking of the smart container flap, tracking of MDP packets being loaded in the smart container, and counting of packets removed. The system has remote patient monitoring (RPM) hub capability and can display medication and schedule information, reminders, and alerts, schedule appointments for review and video consults, and administer active controlled dispensing of MDP packets. The system is capable of tracking time and type of activity, including the number of dispensed units. The system has the ability to remind the patient about the medication schedule using audio-visual means (e.g., light, sound on screen display, notifications via SMS or a smartphone app. In one instance, the device can remind the patient as he or she leaves his or her location to carry medications with the patient if the medications have not been taken. The built-in battery allows power independent operation to ensure events are captured in the event of power loss. The lid and flap mechanisms allow for child/tamper protection. The flap mechanism, if equipped with an image reader, allows for scanning and uniquely identifying each packet dispensed and counting packets removed or pushed back into the smart container. The materials of the housing and lid minimize the amount of UV light exposure. The box can include a window to allow identification of the inserted box with original labelling on the box.

While the invention has been described with respect to exemplary embodiments, other modifications and features should be considered to be within its scope. For example, the smart container 100 was described in the foregoing embodiments as holding an MDP box 10 (that contains a prepacked roll of medication dose packets 12), but the container is also suitable in directly holding the roll of packets 12 or some other cluster form of MDP packs.

Although this invention has been described with respect to certain specific exemplary embodiments, many additional modifications and variations will be apparent to those skilled in the art in light of this disclosure. It is, therefore, to be understood that this invention may be practiced otherwise than as specifically described. Thus, the exemplary embodiments of the invention should be considered in all respects to be illustrative and not restrictive, and the scope of the invention to be determined by any claims supportable by this application and the equivalents thereof, rather than by the foregoing description.

What is claimed is:

1. A container for holding a pre-prepared strip of serially connected pill packets, each packet containing at least one medication, the container comprising:
a housing having plural walls defining a space to receive the strip of pill packets;
a lid secured to the housing, the lid being movable between open and closed positions, the space being accessible when the lid is in the open position;
a dispensing portal disposed at a predetermined position of the housing, the strip of pill packets being dispensable through the dispensing portal; and
a guiding mechanism interconnected with the lid, the guiding mechanism engaging the strip of pill packets when the strip of pill packets is disposed in the space and aligned in the dispensing portal and the lid is moved to the closed position.

2. The container according to claim 1, wherein the guiding mechanism is interconnected with a sensor, the sensor detecting movement of the strip of pill packets as the strip is drawn through the dispensing portal.

3. The container according to claim 2, wherein the guiding mechanism moves as the strip is drawn through the dispensing portal and the movement of the guiding mechanism is used to measure a distance the strip of pill packets moves through the dispensing portal.

4. The container according to claim 1, wherein the guiding mechanism comprises a pair of rollers, the pair of rollers including a first roller disposed on the lid and a second roller connected to the housing, the first roller and the second roller contacting the strip of pill packets when the lid is in the closed position and the strip of pill packets is aligned in the dispensing portal.

5. The container according to claim 1, further comprising a flap connected to the housing adjacent the dispensing portal, the flap being movable between a dispensing position and a closed position, the flap closing access to the dispensing portal when in the closed position.

6. The container according to claim 5, wherein the flap includes a cutting edge for cutting a leading pill packet from the strip of pill packets after the leading pill packet is drawn through the dispensing portal, the cutting edge being usable when the flap is in the dispensing position.

7. The container according to claim 5, wherein the flap is associated with a flap sensor that senses when the flap is moved between the closed position and the dispensing position.

8. The container according to claim 1, wherein the strip of pill packets is stored in a box and the box is insertable in the space in the housing.

9. A method of using a container for holding a pre-prepared strip of serially connected pill packets, each containing at least one medication, the container comprising a housing having plural walls defining a space to receive the strip of pill packets, a dispensing portal disposed at a predetermined position of the housing, the strip of pill packets being dispensable through the dispensing portal, and at least one sensor, the method comprising:
sensing whether a length of the strip of pill packets has been drawn through the dispensing portal; and
storing or transmitting information regarding the length of the strip of pill packets having been drawn through the dispensing portal.

10. The method according to claim 9, wherein the sensor detects movement of the strip of pill packets into and out of the dispensing portal.

11. The method according to claim 9, wherein the container further comprises a flap adjacent the dispensing portal, the flap being movable between a dispensing position and a closed position, and another sensor for sensing the position of the flap, the flap closing access to the dispensing portal when in the closed position,
wherein the method comprises monitoring the position of the flap.

12. The method according to claim 11, further comprising selectively controlling locking and unlocking of the flap in the closed position.

13. The method according to claim 8, further comprising signaling via a device on the container timing regarding when to dispense one of the pill packets.

14. A system for dispensing a pre-prepared strip of serially connected pill packets, each packet containing at least one medication, the system comprising:
a container for holding the pre-prepared strip of serially connected pill packets, the container including a housing defining a space to receive the strip of pill packets, a dispensing portal disposed in the housing, the strip of pill packets being dispensable through the dispensing portal, a guiding mechanism engaging the strip of pill packets when the strip of pill packets is disposed in the space with a leading end of the strip aligned in the dispensing portal, a flap selectively covering the dispensing portal, at least one sensor for sensing a component of the container, a controller in communication with the at least one sensor, and a communication module connected to the controller;
a control portal in communication with the controller, wherein
the controller and control portal control at least one of determining when a packet is to be dispensed from the container, monitoring whether the strip of pill packets has moved through the dispensing portal, determining the distance the strip of pill packets has moved through the dispensing portal, monitoring whether the flap has been moved, or transmitting to the control portal information regarding the container or any components of the container.

15. The system according to claim 14, wherein the guiding mechanism is interconnected with the sensor, the sensor detecting movement of the strip of pill packets as the strip is drawn through the dispensing portal.

16. The system according to claim 15, wherein the guiding mechanism moves as the strip is drawn through the dispensing portal and the movement of the guiding mechanism is used to measure the distance the strip of pill packets moves through the dispensing portal in forward and reverse directions.

17. The system according to claim 14, further comprising a locking mechanism on the container for locking the flap, the controller selectively controlling locking and unlocking of the flap in the closed position.

18. The system according to claim 14, further comprising a signaling device on the container and controlled by the controller, the signaling device signaling the timing regarding when to dispense one of the pill packets.

19. The system according to claim 14, wherein the at least one sensor senses when the flap is moved between a closed position and a dispensing position.

20. The system according to claim 14, wherein the strip of pill packets is stored in a box and the box is insertable in the space in the housing.
